(19) United States
(12) Patent Application Publication
(10) Pub. No.: US 2004/0091402 A1
(43) Pub. Date: May 13, 2004

(54) Insert for an exhaust gas channel

(76) Inventors: Thomas Lewin, Hallstammar (SE); Hans Lovgren, Hallstammar (SE)

Correspondence Address: ALFRED J MANGELS, 4729 CORNELL ROAD, CINCINNATI, OH, 452412433

(21) Appl. No.: 10/381,358

(22) PCT Filed: Oct. 25, 2001
(86) PCT No.: PCT/SE01/02337

(30) Foreign Application Priority Data
Oct. 27, 2000 (SE) 00039289

(51) Int. Cl. B01D 53/34

(52) U.S. Cl. 422/180; 422/177

(57) ABSTRACT

A method of increasing the useful life of heating elements that consist essentially of molybdenum silicide and alloys thereof, wherein the heating elements operate at high temperatures in heat treatment processes and generally rest against the floor and/or the ceiling of a furnace. The heating elements contain aluminum to an extent sufficient to maintain a stable, slowly growing layer of aluminum oxide on the surfaces of the heating elements, and the heating elements are placed in direct abutment with an aluminum oxide brick material.

The present invention relates to an exhaust gas channel insert. One object of the insert is to create turbulence and/or mixing of the gas flowing through the exhaust channel, with the intention of cleansing the exhaust gas.

Different types of inserts of this nature are known to the art. Some consist of plates in which a large number of holes have been punched. Examples of such inserts are net catalysts in which holes have been punched or clipped. This results in a large amount of material waste.

Also available are inserts that consist of a number of layers of net, wire or some other suitable material, where the layers are sintered, welded to rods or fastened mechanically thereto in some other way, such as to hold the layers together. This technique is relatively expensive.

Such known inserts are also difficult, if not impossible, to insert in a curved exhaust channel.

An object of the present invention is to provide an insert which can be produced cheaply and which can be readily inserted into a straight exhaust channel and in a curved exhaust channel.

Accordingly, the present invention relates to an exhaust gas channel insert for generating turbulence in and/or mixing gas flowing through said channel, wherein part of the insert covers the cross-sectional area of the exhaust gas channel, and wherein the invention is characterised in that the insert includes an elongate helical wire element where each wire turn in the helix includes angled portions such that each turn will have an essentially star shape; in that the wire element has along the longitudinal axis of the helix an extension along which the wire is unbroken; and in that the wire element is self-supporting.

The invention will now be described in more detail partly with reference to an exemplifying embodiment of the invention shown in the accompanying drawings, in which

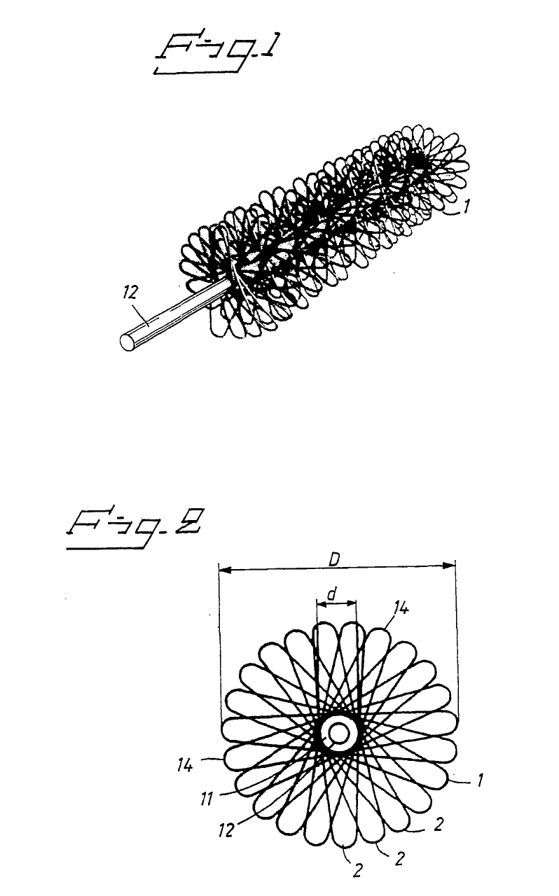

FIG. 1 is a perspective view of an inventive insert;

FIG. 2 shows the insert as seen along its longitudinal axis;

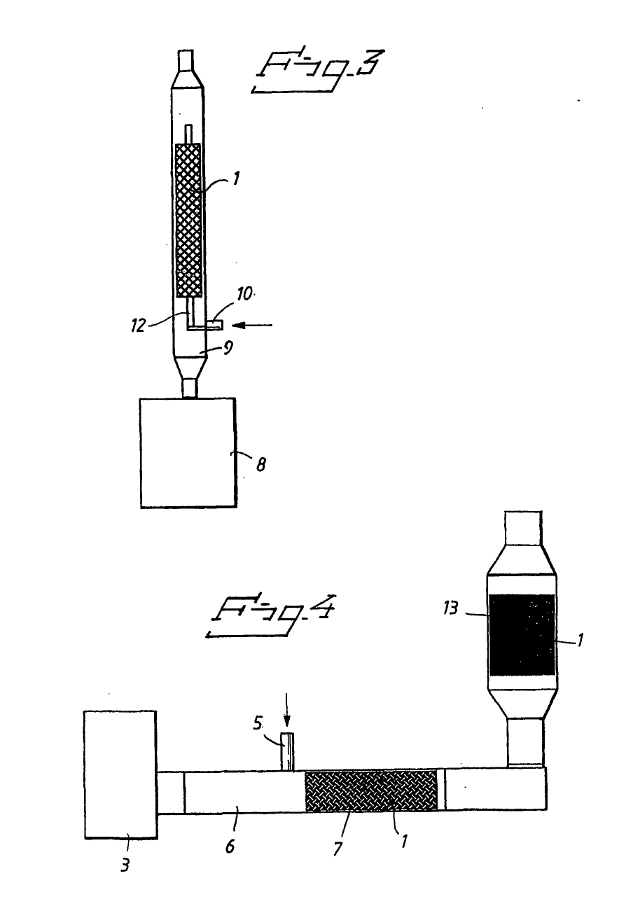

FIG. 3 illustrates an example of one application of the insert; and

FIG. 4 shows another example of an application of the insert.

The inventive insert is intended to be fitted in an exhaust gas channel so as to create turbulence in and/or to cause mixing of the gas flowing through said channel. The insert covers a part of the cross-sectional area of the exhaust gas channel. However, the insert is located over the entire cross-section of the exhaust gas channel.

According to the invention, the insert 1 has the form of an elongate, helical wire element where each wire turn 2 of the helix includes angled portions, so that each turn will have an essentially star shape; see FIG. 2.

The wire element has along the longitudinal axis of the helix an extension along which the wire is unbroken. The wire element is also self-supporting.

A wire element of this construction is marketed by Kanthal AB as a resistance element for heating purposes. The wire element is marketed under the trademark Porcupine.

According to a preferred embodiment, the wire is comprised of a material that includes iron (Fe), chromium (Cr) in quantities of 20-24 percent by weight, and aluminium (Al) in a quantity of 4-10 percent by weight. This enables the wire to resist the high temperatures that exist in an exhaust gas channel. A suitable wire diameter is 0.5 to 3 millimetres.

The insert will conveniently have an outer diameter that corresponds to or that is slightly smaller than the inner diameter of the exhaust gas channel, as illustrated in FIGS. 3 and 4.

It will be evident that as a result of its intricate construction, the wire element will generate a very high turbulence in an exhaust gas channel.

According to one preferred embodiment, the length of the insert exceeds two times its diameter, so as to generate a very high degree of turbulence.

In one embodiment, the insert can function as a mixer. An example of this is shown in FIG. 4, where the reference numeral 3 identifies a burner, the reference numeral 6 identifies an exhaust gas channel, and the reference numeral 5 identifies a secondary air inlet. The secondary air is intended to be mixed with and react with the waste gas from the burner, so as to achieve more complete combustion. In this case, mixing is achieved in the insert 1, as indicated at 7.

FIG. 3 shows another example of an application of the present invention, where the reference numeral 8 identifies a burner, the reference numeral 9 identifies an exhaust gas channel, and the reference numeral 10 identifies a secondary air inlet.

According to one preferred embodiment, the helical wire element 1 is wound so as to form a cylindrical hollow part 11 in the centre of the element 1; see FIG. 2. In FIG. 2, D indicates the outer diameter of the element and d indicates the diameter of the hollow part 11. An element of this nature is self-supporting.

According to an alternative embodiment, an elongate cylindric core 12 of a ceramic material is disposed in the cylindrical hollow part 11. This embodiment will best be seen from FIG. 1.

The wire element can also be wound to enable it to be inserted into a channel between two mutually concentrical pipes. Such an application is found in certain types of burner, of which one such burner is described in Swedish Patent No. 9800473-2.

In the FIG. 3 embodiment, this core 12 has the form of a pipe through which secondary air is passed into the wire element for mixing with the waste gas therein. The pipe or core 12 will suitable have holes in its barrel surface along its length.

According to one highly preferred embodiment of the invention, the wire is coated with one or more catalytic materials. In this regard, it is preferred to coat the wire with platinum (Pt) and/or rhodium (Rh). For instance, the wire may be coated with 10-50% rhodium and 90-50% platinum.

It is preferred to oxidise the element at a high temperature prior to coating the wire, such as to cover the surface of the wire with aluminium oxide (Al₂O₃).

As a result of this coating, the element 1 will function as a catalyst. This is illustrated in FIG. 4, where one such catalyst is referenced 13.

Such a catalyst has a large surface area, generates high turbulence and results in a low drop in pressure.

It will be evident that because of its construction, the insert can be pushed into curved exhaust gas channels and provide therein the same effect as when inserted into straight channels.

For instance, an insert which includes a catalytic coating can be inserted into the exhaust gas channel of an internal combustion engine, and therewith extend from the intake and exhaust manifold of the engine to a position further down in the exhaust channel.

In such applications, and also in other applications, it is preferred that at least those portions of the insert which lie in abutment with the inner surface of said channel are soldered or welded to said surface. In FIG. 2, it is the outer portions 14 that will lie in abutment with the inner surface of the exhaust gas channel.

Although the invention has been described above with reference to a number of embodiments thereof, it will be obvious that the shape of the insert must be adapted to the application for which it is intended.

Consequently, the present invention shall not be considered restricted to the aforedescribed and illustrated exemplifying embodiments thereof, since variations can be made within the scope of the accompanying Claims.

1. An exhaust gas channel insert for generating turbulence and/or for mixing gas flowing through said channel (6; 9), said insert (1) partially covering the cross-sectional area of the exhaust gas channel, characterised in that the insert (1) includes a helical, elongate wire element where each wire turn (2) in the helix includes angled portions such that each turn will have an essentially star shape; in that the wire element has an extension in the longitudinal axial direction of the helix along which the wire is unbroken; and in that the wire element is self-supporting.

2. An insert according to claim 1, characterised in that the length of the insert (1) is more than two times its diameter.

3. An insert according to claims 1 or 2, characterised in that the wire is comprised of a material that includes iron (Fe), chromium (Cr) and aluminium (Al).

4. An insert according to claims 1, 2 or 3, characterised in that the wire is coated with one or more catalytic materials.

5. An insert according to claims 1, 2, 3 or 4, characterised in that the wire is coated with platinum (Pt) and/or rhodium (Rh).

6. An insert according to claims 1, 2, 3, 4 or 5, characterised in that at least those portions (14) of the insert which lie against the inner surface of said exhaust gas channel (6; 9) are soldered or welded to said inner surface.

7. An insert according to claims 1, 2, 3, 4, 5 or 6, characterised in that the helical wire element is wound such as to form a cylindrical hollow portion (11) in the centre of the element.

8. An insert according to claim 7, characterised in that an elongate cylindrical core (12) of a ceramic material is disposed in said cylindrical hollow portion (11).
